(19) United States
(12) Patent Application Publication
(10) Pub. No.: US 2025/0372867 A1
(43) Pub. Date: Dec. 4, 2025

(54) Method, device and equipment for actively controlling antenna pointing under the influence of environmental factors

(71) Applicant: Northwest China Research Institute of Electronic Equipment (NWIEE), Xi'an (CN)

(72) Inventors: Dongwei Li, Xi'an (CN); Wulin Zhao, Xi'an (CN); Fa Yang, Xi'an (CN); Yan Li, Xi'an (CN); Hongwei Li, Xi'an (CN); Gengxin He, Xi'an (CN); Hongtao Yan, Xi'an (CN); Fuyu Long, Xi'an (CN); Lisheng Wang, Xi'an (CN); Wei Zhang, Xi'an (CN); Hao Duan, Xi'an (CN); Chengxian Ge, Xi'an (CN); Yi Liu, Xi'an (CN); Kangle Hu, Xian (CN)

(73) Assignee: Northwest China Research Institute of Electronic Equipment (NWIEE), Xi'an, SN (CN)

(21) Appl. No.: 19/301,858

(22) Filed: Aug. 15, 2025

(30) Foreign Application Priority Data
Nov. 26, 2024 (CN) 202411697246.9

(51) Int. Cl. H01Q 3/08

(52) U.S. Cl. CPC H01Q 3/08

(57) ABSTRACT

The present disclosure discloses a method, device and equipment for actively regulating antenna pointing under the influence of environmental factors, and relates to the technical field of antenna performance regulation. By pre-establishing the correspondence between the wind force information and wind field, temperature information and temperature field of the preset antenna points, after obtaining the wind force information and temperature information of the preset antenna points in the current preset period, matching is directly performed based on the correspondences, and the perception of the wind field and temperature field in the current preset period is completed in real time, and then the temperature field and wind field of the antenna at the next moment are predicted based on the second prediction model that pre-learns the evolution relationship of the wind field and the temperature field, and the antenna pointing deviation at the next moment is predicted based on the antenna pointing deviation prediction model that pre-learns the correlation between the wind field and the temperature field and the antenna pointing deviation, so as to achieve early prediction of the antenna pointing deviation, so as to actively regulate the antenna pointing, thereby the antenna can timely point to the detection target at the next moment, and improve the accuracy and performance of the antenna.

### TECHNICAL FIELD

The present disclosure relates to the field of antenna performance control, and in particular to a method, device and equipment for actively controlling antenna pointing under the influence of environmental factors.

### BACKGROUND

At present, antennas are widely used in many fields of national defense, military and national economy, such as communication, navigation, positioning, radar, radio astronomy, satellite broadcasting and television. In deep space exploration missions, due to the extremely long detection distance, the electromagnetic wave signal becomes extremely weak. This puts higher requirements on deep space exploration antennas as transmitting and receiving terminal devices. Not only they must have higher radio gain, but they also require high-precision pointing and good tracking performance. Therefore, the size/diameter of this type of antenna is often larger.

Since large reflector antennas are usually located in relatively open outdoor environments, although the huge size of the main reflector (reflecting surface) brings excellent observation performance, it is also easily affected by a variety of external factors. Among them, temperature and gusts have the greatest impact on the antenna. In an open-air field environment, the antenna is affected by gusts almost all the time. Gusts will apply force loads to the antenna, causing the antenna structure to deform and causing changes in the antenna's direction. As for temperature, since the antenna is exposed to the sun for a long time, different sunshine conditions will produce shadow areas at different positions of the antenna structure, resulting in uneven heating of the antenna, deformation of the antenna structure, and changes in the antenna's direction/pointing. Changes in the antenna's direction/pointing will reduce its accuracy and performance.

In summary, there is an urgent need for a method to correct the antenna pointing under the influence of gusts and temperature to improve the accuracy and performance of the antenna.

### SUMMARY

Based on this, it is necessary to provide a method, device and equipment for actively controlling antenna pointing under the influence of environmental factors to address the above technical problems.

The present invention adopts the following technical solutions:

The present invention provides a method for actively controlling/regulating antenna pointing under the influence of environmental factors. First, the correspondences between wind information and wind field, temperature information and temperature field of preset antenna points are established, and the true deviation of the antenna pointing under the influence of historical wind field and historical temperature field is obtained, so that a first prediction model is trained according to the historical wind field, historical temperature field and the true deviation to obtain an antenna pointing deviation prediction model for predicting the antenna pointing deviation, and then the wind information and temperature information of the preset antenna points in the current preset time period are obtained, so as to determine the temperature field and wind field of the antenna in the current preset time period according to the correspondences determined in the previous step, and predict the predicted temperature field and predicted wind field of the antenna at the next moment, so as to predict the pointing deviation of the antenna under the influence of the predicted temperature field and predicted wind field of the antenna at the next moment through the antenna pointing deviation prediction model, and finally the pointing of the antenna can be actively regulated according to the predicted pointing deviation.

The present invention provides a device for actively controlling antenna pointing under the influence of environmental factors, comprising:
an acquisition module, configured for determining a historical wind field and a historical temperature field of an antenna according to wind force information and temperature information of preset antenna points at multiple historical moments, so as to establish a first correspondence between the wind force information and the wind field of the preset antenna points and a second correspondence between the temperature information and the temperature field of the preset antenna points;
a deviation module, configured for obtaining a true deviation of the antenna pointing under the influence of the historical wind field and the historical temperature field, so as to train a first prediction model according to the historical wind field, the historical temperature field and the true deviation, and obtain an antenna pointing deviation prediction model for predicting the antenna pointing deviation;
a determination module, configured for obtaining the wind force information and temperature information of the preset antenna points within a current preset period, determining the wind field of the antenna within the current preset period according to the wind force information of the preset antenna points and the first correspondence, and determining the temperature field of the antenna within the current preset period according to the temperature information of the preset antenna points and the second correspondence;
a prediction module, configured for predicting a predicted temperature field and a predicted wind field of the antenna at a next moment by a second prediction model based on the wind field and temperature field of the antenna in the current preset time period, wherein the second prediction model is obtained through training by taking the wind field and temperature field of the antenna in a historical time period as samples and the wind field and temperature field of the antenna at the next moment after the historical time period as annotations;
a control module, configured for inputting the predicted temperature field and predicted wind field of the antenna at the next moment into the antenna pointing deviation prediction model to determine a pointing deviation of the antenna under the influence of the predicted temperature field and the predicted wind field so as to actively adjust a pointing direction of the antenna so that the antenna can accurately point to a target at the next moment.

The present invention provides a computer-readable storage medium, wherein the storage medium stores a computer program, and when the computer program is executed by a processor, the above-mentioned method for actively controlling antenna pointing under the influence of environmental factors is implemented.

The present invention provides a computer device, including a memory, a processor, and a computer program stored in the memory and executable on the processor, wherein the processor executes the program, the method for actively controlling antenna pointing under the influence of environmental factors is implemented.

At least one of the above technical solutions adopted by the present invention can achieve the following beneficial effects:

The present invention establishes in advance the correspondences between the wind information and wind field, and the temperature information and temperature field of the preset antenna points. Therefore, in practical applications, after obtaining the wind information and temperature information of the preset antenna points in the current preset time period, the correspondence can be directly matched, and the wind field and temperature field in the current preset time period can be perceived quickly and in real time. Then, the temperature field and wind field of the antenna at the next moment are predicted based on the second prediction model that has pre-learned the evolution relationship of the wind field and the temperature field, and the pointing deviation of the antenna at the next moment is predicted based on the antenna pointing deviation prediction model that has pre-learned the correlation between the wind field and the temperature field and the antenna pointing deviation, thereby realizing early prediction of the antenna pointing deviation, and actively adjusting the antenna pointing, so that the antenna can timely point to the detection target at the next moment, thereby improving the accuracy and performance of the antenna.

### BRIEF DESCRIPTION OF THE DRAWINGS

The drawings described herein are used to provide a further understanding of the present invention and constitute a part of the present invention. The exemplary embodiments of the present invention and their descriptions are used to explain the present invention and do not constitute an improper limitation of the present invention. In the drawings:

FIG. 1 is a schematic flow chart of a method for actively controlling antenna pointing under the influence of environmental factors provided by the present invention;

FIG. 2 is a schematic diagram of a neural network model prediction provided by the present invention;

FIG. 3 is a schematic diagram of an application process of active antenna pointing control provided by the present invention;

FIG. 4 is a schematic diagram of a device for actively controlling antenna pointing under the influence of environmental factors provided by the present invention.

### DETAILED DESCRIPTION OF EMBODIMENTS

In order to make the purposes, technical solutions and advantages of the present invention clearer, the technical solutions of the present invention will be clearly and completely described below in conjunction with the specific embodiments of the present invention and the corresponding drawings. Obviously, the described embodiments are only part of the present invention, not all of the embodiments. Based on the embodiments of the present invention, all other embodiments obtained by ordinary technicians in this field without making creative work are within the scope of protection of the present invention.

The technical solutions provided by various embodiments of the present invention are described in detail below in conjunction with the accompanying drawings.

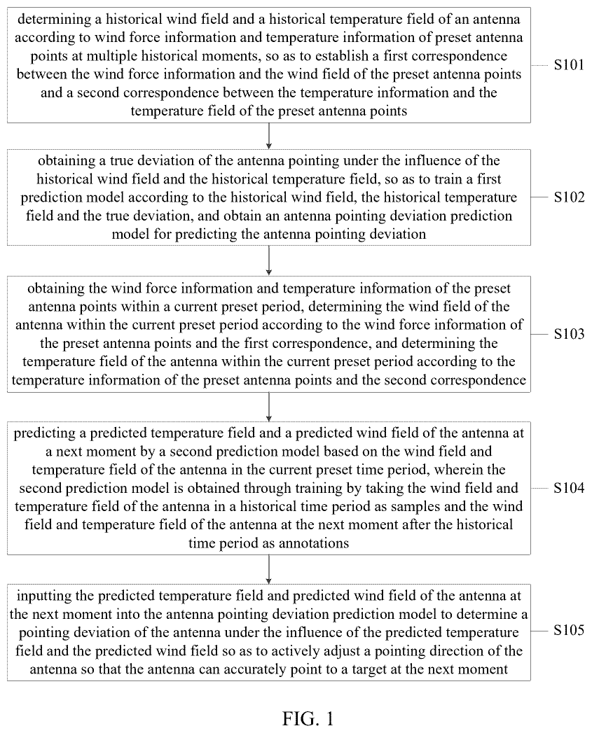

FIG. 1 is a flow chart of a method for actively controlling antenna pointing under the influence of environmental factors in the present invention, which specifically includes the following steps:

S101: Determine the historical wind field and the historical temperature field of the antenna based on the wind force information and temperature information of the preset antenna points at multiple historical moments, so as to establish a first correspondence between the wind force information and the wind field of the preset antenna points and a second correspondence between the temperature information and the temperature field of the preset antenna points.

S102: Acquire the true deviation of the antenna pointing under the influence of the historical wind field and the historical temperature field, train the first prediction model according to the historical wind field, the historical temperature field and the true deviation, and obtain an antenna pointing deviation prediction model for predicting the antenna pointing deviation.

S103: Obtain wind force information and temperature information of the preset antenna points within a current preset period, determine the wind field of the antenna within the current preset period based on the wind force information of the preset antenna points and the first correspondence, and determine the temperature field of the antenna within the current preset period based on the temperature information of the preset antenna points and the second correspondence.

S104: Predict the predicted temperature field and predicted wind field of the antenna at the next moment based on the wind field and temperature field of the antenna in the current preset time period through a second prediction model; the second prediction model is trained with the wind field and temperature field of the antenna in the historical time period as samples and the wind field and temperature field of the antenna at the moment after the historical time period as annotations.

S105: Input the predicted temperature field and predicted wind field of the antenna at the next moment into the antenna pointing deviation prediction model, determine the pointing deviation of the antenna under the influence of the predicted temperature field and the predicted wind field to actively adjust the pointing direction of the antenna, so that the antenna can accurately point to the target at the next moment.

For the convenience of explanation, the following description is only based on the server as the execution subject. The server mentioned in the present invention can be a server set up on a business platform, or a device such as a desktop computer, a notebook computer, etc. that can execute the solution of the present invention.

As one of the main loads borne by the antenna, wind load in the natural environment can usually be divided into two types: steady-state wind and transient wind. The period of steady-state wind is generally much longer than the natural vibration period of the reflector structure of the antenna. Its influence on the reflector structure can be regarded as a static force that does not change with time, and is thus applied to the reflector structure in the form of a static load for analysis. The period of transient wind is shorter, and its effect is dynamic, which will cause the vibration of the reflector structure, and the vibration of the reflector structure will cause the change of the antenna pointing. For the larger size/diameter of the radio telescope, both steady-state wind and transient wind will generate a certain torque on the reflector structure of the antenna. Under the influence of this torque, the antenna will undergo a certain torsional deformation, thereby causing the change of the antenna pointing.

Since wind disturbances are highly pulsating and actual measurement or calculation requires a certain amount of time, wind disturbance control has a certain time lag. This means that when the wind acts on the antenna reflection surface, the control system cannot make real-time adjustments based on the received interference signal. This requires reasonable prediction of incoming wind information and calculation of the adjustment amount in advance.

Temperature load is another major load that the antenna bears, and its most notable feature is that it is greatly affected by sunlight. Any material will produce a certain degree of deformation under an uneven temperature field. Since the antenna is always in a natural environment, it will be affected by sunlight. The sunlight will produce shadow areas on the reflective surface and the back frame, resulting in uneven heating of the antenna, which is easy to cause deformation of the reflective surface and the back frame, thus affecting the final pointing and gain performance of the antenna.

Therefore, in order to ensure the accuracy and real-time acquisition of the antenna temperature field, it is necessary to use appropriate methods to use the temperature data measured by a small number of temperature sensors to accurately reconstruct the overall temperature field distribution of the antenna, and predict the changes in the temperature field at subsequent moments. In order to comprehensively consider the interference of the wind field and temperature field on the antenna, the deviation value from the ideal pointing can be calculated in advance at all times, and the antenna pointing can be corrected in advance by adjusting the control instructions of the control system, thereby promptly eliminating the adverse effects of wind disturbances and temperature on the antenna pointing.

In one or more embodiments of the present invention, the method for actively controlling antenna pointing under the influence of environmental factors may mainly include three parts: information collection and transmission, data processing, and performance control.

Herein, the information collection are mainly performed at the preset antenna points of the antenna reflector, the information on the surrounding environmental factors is collected when the antenna is working, as well as the real-time changes in the antenna pointing under the influence of environmental factors. For example, wind speed and direction sensors can be evenly arranged along the height direction of the antenna. To ensure the accuracy of the measurement data, the number of the set sensors can be determined according to the antenna size and height. Generally, at least 3 to 5 are required. Each wind speed and direction sensor can be set on the antenna mount, pitch frame, reflector back frame and other parts according to the needs of information collection. Of course, a truss structure dedicated to the arrangement of wind speed and direction sensors can also be established around the antenna tower base (3 to 5 meters away from the edge of the antenna shape). Temperature sensors can be mainly arranged at different positions of the reflector back frame structure.

In order to accurately arrange the temperature sensors, in one or more embodiments of the present invention, the server may establish a finite element analysis model of the antenna according to the reflector structure of the antenna. And according to the finite element analysis model of the antenna, temperature loads of different temperature values and different temperature gradients are applied, and the deformation of the reflector structure of the antenna under different temperature loads is calculated, and a deformation cloud map of the reflector structure is drawn. Thus, according to the degree of structural deformation of each area in the deformation cloud map of the reflector structure and the preset deformation threshold, the thermal sensitive points of the reflector structure of the antenna are determined. The various temperature sensors can be set at the thermal sensitive points of the reflector structure of the antenna, and the thermal sensitive point of the reflector structure of the antenna is used as a preset point. By searching for areas with larger structural deformation in the deformation cloud map of different temperature loads as preset points and arranging temperature sensors, the utilization efficiency of the temperature sensors can be improved.

For the impact of wind disturbance, the main thing is to collect wind information such as wind speed and direction. Later, based on the wind information, the real-time distribution of the wind field of the antenna reflector structure can be inverted by region. For the impact of temperature field, the main thing is to collect temperature information of different thermal sensitive points, and also invert the real-time distribution of the temperature field of the antenna reflector structure.

After obtaining the temperature information, in one or more embodiments of the present invention, the server may use a segmented and regional Hermite interpolation method for the reflector structure of the antenna according to the temperature information of preset points of the reflector structure of the antenna to determine the temperature information of each structural node of the reflector structure of the entire antenna; and then, based on the temperature information of each structural node of the reflector structure of the entire antenna, deduce the temperature field of the reflector structure of the entire antenna through an orthogonal matching pursuit (OMP) algorithm.

For the wind field, in one or more embodiments of the present invention, the server can couple the ideal wind field model at the antenna site and the reflector structure of the antenna under different working conditions and corresponding postures through a machine learning model. The different working conditions include: different azimuths, different elevation angles, and different windward areas. That is, the reflector structure of the antenna here can be a reflector structure under different azimuths, elevation angles, and different windward areas when the antenna is working, so as to determine the wind field under different working conditions and corresponding postures when the antenna is working. When studying and regulating a certain target antenna, it can be transferred to the target antenna through transfer learning to obtain the wind field under different working conditions and corresponding postures when the target antenna is working. After that, multiple preset points can be selected from the reflector structure of the antenna so that the wind information of each preset point can characterize the entire wind field of the antenna to the greatest extent. Of course, the preset points of the wind information here may be different from the preset points of the aforementioned temperature information.

Furthermore, after completing the information collection and transmission part, the server can further perform data processing. In one or more embodiments of the present invention, the server can obtain the wind information and temperature information of the preset antenna point at multiple historical moments, and establish a first correspondence between the wind information of the preset antenna point and the wind field and a second correspondence between the temperature information of the preset antenna point and the temperature field.

Specifically, the server can further record the wind force information of each preset point under each corresponding posture of the same working condition when the antenna is working and the first correspondence relationship (wind field database) of the entire wind field. When applied, whenever the wind force information at each key point of the reflector structure of the antenna at the current moment is obtained, the correspondence recorded is traversed and the wind force information at the key point of the current working condition is matched, so that the corresponding entire wind field information in the matched record is used as the wind field of the antenna at the current moment. By completing a large amount of data matching work in the early stage, the wind field of the antenna can be determined by a small amount of key point data in the subsequent actual application, further improving the timeliness of antenna control.

Similarly to wind fields, the server can construct a second correspondence (temperature field database) between the historical temperature field of the antenna at historical moments and the historical temperature information of the preset points of the reflector structure of the antenna. Then, whenever the temperature information at the key points of the reflector structure of the antenna at the current moment is obtained, the corresponding historical temperature field can be determined as the temperature field of the antenna at the current moment based on the matching relationship between the temperature information at the key points of the reflector structure of the antenna at the current moment and the historical temperature information. Similarly, a large amount of data matching work is completed through the accumulation of early data. In subsequent practical applications, the temperature field of the antenna can be quickly and real-timely determined through a small amount of key point data, further improving the timeliness of antenna control.

Wind disturbance and temperature change mainly affect the pointing accuracy of the antenna. The change of antenna pointing is mainly observed by observing the known detection target (such as a known radio source or satellite). The method is to point the antenna in the direction of the detection target, use the spectrum analyzer and servo controller to record the actual azimuth and actual elevation of the antenna when the antenna points to the detection target, and use the spatial position relationship between the known detection target and the antenna site to calculate the theoretical azimuth and theoretical elevation of the antenna when pointing to the target radio source or satellite. The difference between the two can be used to obtain the antenna pointing deviation under the influence of the environmental load at this moment.

Furthermore, in one or more embodiments of the present invention, the server may store data and establish an antenna pointing deviation database. Of course, the environmental factors when determining the antenna pointing deviation, namely the temperature field and wind field of the antenna, may be recorded accordingly.

Here, the server can use the historical wind field and historical temperature field recorded in the antenna pointing deviation database as sample data, and use the true deviation of the antenna pointing under the influence of environmental factors at historical moments as a label/annotation. Through machine learning, physical neural networks and other artificial intelligence methods, the server can explore and learn the mapping relationship between the wind field, temperature field distribution and pointing deviation of the antenna. The mapping relationship learned by the first prediction model can be shown as follows:

$${R}_{i \to j} = {\sum }_{k = 1}^{n} {b}_{k} {c}_{k} {I}_{{nf}_{k}} .$$

Among them, R_{i→j} represents the mapping relationship between the wind field and temperature field distribution of the antenna and the antenna pointing deviation at the corresponding historical moment, b=(b₁,b₂, . . . ,bₙ) is the weight of the influence of the wind field on the pointing deviation inferred from different dimensions (The wind field generally has a gradient along the height direction. Since the vertical height of the large-diameter antenna is often tens of meters or even hundreds of meters, the prediction model needs to consider the wind field information in different height directions), and

$${\sum }_{k = 1}^{n} {b}_{k} = 1 ; c = ( {c}_{1} , {c}_{2} , … , {c}_{n} )$$

is the weight of the influence of the temperature field on the pointing deviation inferred from different dimensions (The diameter of the large-diameter antenna is often large, and there is a temperature difference in different areas. At the same time, due to the obstruction of the antenna reflector panel, shaded areas may appear on the back frame and the seat frame, which has an obvious temperature difference with the directly irradiated area. Therefore, the prediction model needs to consider the temperature information at key nodes at different vertical heights and different horizontal positions), and

$${\sum }_{k = 1}^{n} {c}_{k} = 1 ; {I}_{nf} = ( {I}_{{nf}_{1}} , {I}_{{nf}_{2}} , … , {I}_{{nf}_{n}} )$$

is the mapping relationship between the environmental load and the antenna pointing deviation judged from different dimensions (different dimensions of the wind field and different dimensions of the temperature field).

During the training process of the first prediction model, the first prediction model can determine the predicted deviation of the antenna pointing under the influence of environmental factors at historical moments, and the first prediction model is trained with the goal of minimizing the difference between the predicted deviation and the true deviation, thereby gradually learning the mapping relationship between the wind field and temperature field distribution of the antenna and the pointing deviation, and obtaining the antenna pointing deviation prediction model.

In the subsequent application process, the server may first obtain the collected wind information and temperature information of the key points in the reflector structure of the antenna, and then determine the wind field of the antenna in the current preset time period based on the wind information of the preset antenna points and the first correspondence, and determine the temperature field of the antenna in the current preset time period based on the temperature information of the preset antenna points and the second correspondence.

After obtaining the temperature field and wind field of the antenna in the current preset time period, the server can predict the predicted temperature field and predicted wind field of the antenna at the next moment based on the temperature field and wind field of the antenna in the current preset time period through the pre-trained second prediction model. The second prediction model here is to distinguish from the first prediction model for learning the mapping relationship between the wind field, temperature field distribution and pointing deviation of the antenna. Specifically, the second prediction model can be two neural network models to predict the wind field at the next moment and the temperature field at the next moment respectively.

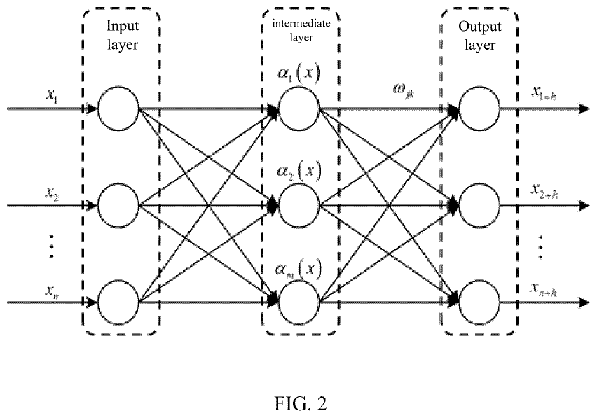

Since the wind speed at adjacent moments is highly correlated, a model can be established based on the relationship between the wind speed at the moment t and the previous wind speed before t. Assume that there is a function F such that: x(t+h)=F[x(t)], where x(t) is the wind field at moment t, x(t+h) is the wind field at moment t+h, and h is the prediction step length. The wind field of the antenna at the next moment can be predicted by the neural network model shown in FIG. 2.

FIG. 2 is a schematic diagram of a neural network model for predicting wind field in the present invention. For the moment t the wind field of the antenna is x(t)={xᵢ(t),i=1,2 . . . , N}, xⁱ(t) is i-th wind speed sequence in the wind field, and N is the number of sequences.

As shown in FIG. 2, when performing wind field prediction, the model and training logic of the middle layer are as follows: first use the P values [x(t−p+1), . . . ,x(t−1),x(t)] before t+1 to obtain the predicted value x(t+1) through training, then update the sequence, add the first predicted value to the sequence, remove the value of the farthest point, and use [x(t−p+2), . . . ,x(t), x(t+1)] to predict x(t+2), and so on, and recycle the model to realize wind speed prediction.

The temperature field and the wind field have the same properties, and the temperature fields at adjacent moments are also highly correlated. Therefore, a model can also be established based on the relationship between the wind speed at time t and the wind speed before time t. There exists a function G such that: y(t+h)=G[y(t)], where y(t) is the wind field at time t, y(t+h)t, is the wind field at time t+h, and h is the prediction step length. The logic and architecture of the temperature field prediction model are similar to those of the wind field prediction model.

In addition, it can be seen from the above that wind is caused by air flow, and temperature is mostly caused by solar radiation. The temperature and wind characteristic information at the next moment are strongly correlated with the information at the previous moment. The previous moment does not specifically refer to the previous moment relative to the next moment, but the previous period or time period. This time period is relatively short for steady-state temperature and wind, and relatively long for transient temperature and wind. The determination of this period requires continuous optimization of the minimum deviation and threshold under different circumstances during the training process, and the historical data period required for prediction of different situations is also different. It can be determined according to needs, and this specification does not limit this.

After obtaining the predicted temperature field and predicted wind field of the antenna at the next moment, performance control can be performed. The server can input it into the aforementioned antenna pointing deviation prediction model to determine the pointing deviation of the antenna under the influence of the predicted temperature field and the predicted wind field, and actively control the pointing of the antenna according to the pointing deviation of the antenna under the influence of the predicted temperature field and the predicted wind field, so that the antenna can accurately point to the target at the next moment. Specifically, in one or more embodiments of the present invention, the server can decompose the pointing deviation of the antenna under the influence of environmental factors according to the corresponding control factors of each control link of the antenna control system, and then actively control the pointing of the antenna based on each control factor through the antenna control system, so that the antenna can accurately point to the detection target at the next moment. Wherein, the control factors include: azimuth angle, elevation angle, torque in each direction of the azimuth motor, and control torque in each direction of the pitch motor.

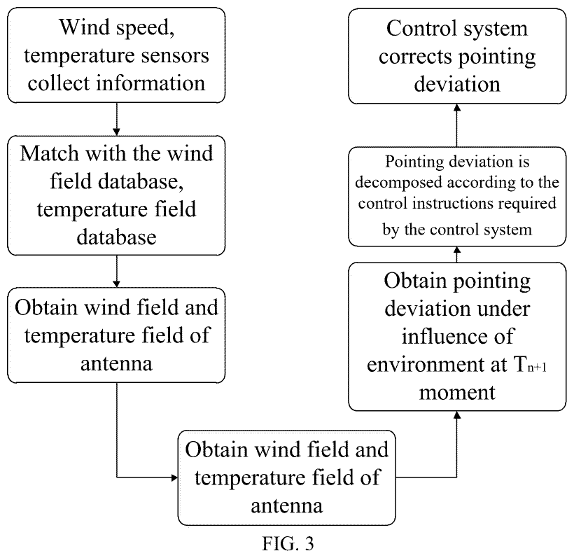

FIG. 3 is a schematic diagram of an application process of active antenna pointing control in the present invention. It can be mainly divided into four steps, the first step is environmental monitoring, the second step is advance prediction, the third step is deviation matching, and the fourth step is pointing correction. Specifically, it can be divided into the following key links: (1) Obtain wind information and temperature information of key points of the reflector structure of the antenna collected by wind speed and wind direction sensors and temperature sensors in real time during the current preset time period; (2) Match the wind information and temperature information obtained in real time with the pre-built wind field database and temperature field database; (3) Determine the wind field and temperature field of the antenna in the current preset time period corresponding to the matched data; (4) Predict the wind field and temperature field around the antenna at the next moment based on the wind field and temperature field of the antenna in the current preset time period; (5) The mapping relationship between the pointing deviation and the predicted value of the antenna pointing deviation under the influence of the wind field and temperature field at the next moment is obtained through prediction; (6) The predicted value of the pointing deviation is decomposed according to the control instructions required by each control link of the control system, such as azimuth angle, elevation angle, torque required in each direction of the azimuth motor, control torque required in each direction of the pitch motor, etc.; (7) According to the decomposed control instructions, each control link is reversely adjusted and compensated, and the pointing deviation caused by environmental factors is corrected in advance and actively, so as to ensure the pointing accuracy and performance of the antenna at the next moment, and achieve real-time perception, early prediction, and active regulation.

Based on the method for active control of antenna pointing under the influence of environmental factors shown in FIG. 1, the correspondences between the wind information and wind field, temperature information and temperature field of the preset antenna point are first established, and the true deviation of the antenna pointing under the influence of the historical wind field and the historical temperature field is obtained, so as to train the first prediction model according to the historical wind field, the historical temperature field and the true deviation, and obtain an antenna pointing deviation prediction model for predicting the antenna pointing deviation, and then obtain the wind information and temperature information of the preset antenna point in the current preset time period, so as to determine the temperature field and wind field of the antenna in the current preset time period according to the correspondence determined in the previous step, and predict the predicted temperature field and predicted wind field of the antenna at the next moment, so as to predict the pointing deviation of the antenna under the influence of the predicted temperature field and predicted wind field of the antenna at the next moment through the antenna pointing deviation prediction model, and finally the antenna pointing can be actively controlled according to the predicted pointing deviation.

The present invention establishes in advance the correspondences between the wind information and wind field, and the temperature information and temperature field of the preset antenna points. Therefore, in practical applications, after obtaining the wind information and temperature information of the preset antenna points in the current preset time period, the correspondences can be directly matched, and the wind field and temperature field in the current preset time period can be perceived quickly and in real time. Then, the temperature field and wind field of the antenna at the next moment are predicted based on the second prediction model that has pre-learned the evolution relationship of the wind field and the temperature field, and the pointing deviation of the antenna at the next moment is predicted based on the antenna pointing deviation prediction model that has pre-learned the correlation between the wind field and the temperature field and the antenna pointing deviation, thereby realizing early prediction of the antenna pointing deviation, and actively adjusting the antenna pointing, so that the antenna can timely point to the detection target at the next moment, thereby improving the accuracy and performance of the antenna.

When applying the method for actively controlling antenna pointing under the influence of environmental factors provided by the present invention, the steps may not be executed in the order shown in FIG. 1. The specific execution order of the steps may be determined as required, and the present invention does not impose any limitation on this.

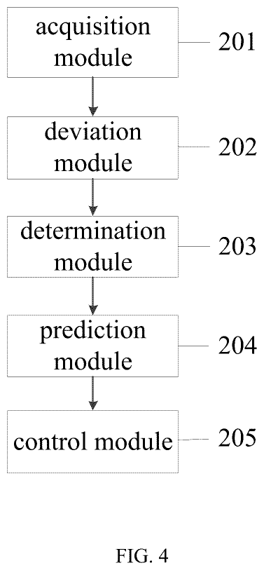

The above is a method for actively controlling antenna pointing under the influence of environmental factors provided by one or more embodiments of the present invention. Based on the same idea, the present invention also provides a corresponding device for actively controlling antenna pointing under the influence of environmental factors, as shown in FIG. 4.

FIG. 4 is a schematic diagram of a device for actively controlling antenna pointing under the influence of environmental factors provided by the present invention, comprising:

The acquisition module 201 is used to determine the historical wind field and the historical temperature field of the antenna according to the wind force information and the temperature information of the preset antenna point at multiple historical moments, so as to establish a first correspondence between the wind force information and the wind field of the preset antenna point and a second correspondence between the temperature information and the temperature field of the preset antenna point;

The deviation module 202 is used to obtain the true deviation of the antenna pointing under the influence of the historical wind field and the historical temperature field, so as to train the first prediction model according to the historical wind field, the historical temperature field and the true deviation to obtain the antenna pointing deviation prediction model for predicting the antenna pointing deviation;

The determination module 203 is used to obtain the wind force information and temperature information of the preset antenna points in the current preset period, determine the wind field of the antenna in the current preset period according to the wind force information of the preset antenna points and the first correspondence, and determine the temperature field of the antenna in the current preset period according to the temperature information of the preset antenna points and the second correspondence;

The prediction module 204 is used to predict the predicted temperature field and predicted wind field of the antenna at the next moment according to the wind field and temperature field of the antenna in the current preset time period through a second prediction model; the second prediction model is obtained through training by taking the wind field and temperature field of the antenna in the historical time period as samples and the wind field and temperature field of the antenna at the next moment after the historical time period as annotations;

The control module 205 is used to input the predicted temperature field and predicted wind field of the antenna at the next moment into the antenna pointing deviation prediction model, determine the pointing deviation of the antenna under the influence of the predicted temperature field and the predicted wind field to actively control the pointing of the antenna, so that the antenna can accurately point to the target at the next moment.

For the specific limitations of the device for actively controlling the antenna pointing under the influence of environmental factors, please refer to the limitations of the method for actively controlling the antenna pointing under the influence of environmental factors above, which will not be repeated here. Each module in the device for actively controlling the antenna pointing under the influence of environmental factors can be implemented in whole or in part by software, hardware, and a combination thereof. Each of the above modules can be embedded in or independent of a processor in a computer device in the form of hardware, or can be stored in a memory in a computer device in the form of software, so that the processor can call and execute operations corresponding to each of the above modules.

The present invention also provides a computer-readable storage medium, which stores a computer program. The computer program can be used to execute the method for actively controlling antenna pointing under the influence of environmental factors provided in FIG. 1 above.

The present invention also provides a computer device, which includes a processor, an internal bus, a network interface, a memory, and a non-volatile memory at the hardware level, and may also include hardware required for other services. The processor reads the corresponding computer program from the non-volatile memory into the memory and then runs it to implement the active antenna pointing control method under the influence of environmental factors provided in FIG. 1 above.

Those skilled in the art can understand that all or part of the processes in the above-mentioned embodiment methods can be completed by instructing the relevant hardware through a computer program, and the computer program can be stored in a non-volatile computer-readable storage medium. When the computer program is executed, it can include the processes of the embodiments of the above-mentioned methods. Among them, any reference to memory, storage, database or other media used in the embodiments provided by the present invention can include at least one of non-volatile and volatile memory. Non-volatile memory can include read-only memory (ROM), magnetic tape, floppy disk, flash memory or optical memory, etc. Volatile memory can include random access memory (RAM) or external cache memory. As an illustration and not limitation, RAM can be in various forms, such as static random access memory (SRAM) or dynamic random access memory (DRAM).

The technical features of the above embodiments may be arbitrarily combined. To make the description concise, not all possible combinations of the technical features in the above embodiments are described. However, as long as there is no contradiction in the combination of these technical features, they should be considered to be within the scope of the present invention.

What is claimed is:

1. A method for actively controlling antenna pointing under the influence of environmental factors, comprising:
determining a historical wind field and a historical temperature field of an antenna according to wind force information and temperature information of preset antenna points at multiple historical moments, so as to establish a first correspondence between the wind force information and the wind field of the preset antenna points and a second correspondence between the temperature information and the temperature field of the preset antenna points;
obtaining a true deviation of the antenna pointing under the influence of the historical wind field and the historical temperature field, so as to train a first prediction model according to the historical wind field, the historical temperature field and the true deviation, and obtain an antenna pointing deviation prediction model for predicting the antenna pointing deviation;
obtaining the wind force information and temperature information of the preset antenna points within a current preset period, determining the wind field of the antenna within the current preset period according to the wind force information of the preset antenna points and the first correspondence, and determining the temperature field of the antenna within the current preset period according to the temperature information of the preset antenna points and the second correspondence;
predicting a predicted temperature field and a predicted wind field of the antenna at a next moment by a second prediction model based on the wind field and temperature field of the antenna in the current preset time period, wherein the second prediction model is obtained through training by taking the wind field and temperature field of the antenna in a historical time period as samples and the wind field and temperature field of the antenna at the next moment after the historical time period as annotations;
inputting the predicted temperature field and predicted wind field of the antenna at the next moment into the antenna pointing deviation prediction model to determine a pointing deviation of the antenna under the influence of the predicted temperature field and the predicted wind field so as to actively adjust a pointing direction of the antenna so that the antenna can accurately point to a target at the next moment.

2. The method according to claim 1, wherein the step of determining a historical temperature field of an antenna according to temperature information of preset antenna points at multiple historical moments specifically comprises:
establishing a finite element analysis model of the antenna according to a reflector structure of the antenna;
applying temperature loads with different temperature values and different temperature gradients according to the finite element analysis model of the antenna, and calculating deformation of the reflector structure of the antenna under different temperature loads, and drawing a deformation cloud map of the reflector structure;
determining thermal sensitive points of the reflector structure of the antenna according to a structural deformation degree of each area in the reflector structure deformation cloud map and a preset deformation threshold;
taking the thermal sensitive points of the reflector structure of the antenna as preset points, and obtaining the temperature information of the preset antenna points at multiple historical moments to determine the historical temperature field of the antenna;
wherein establishing a first correspondence between the wind force information and the wind field of the preset antenna points specifically comprises:
an ideal wind field model at the antenna site and the reflector structure of the antenna under different working conditions are coupled by a machine learning model to determine the wind field under different working conditions when the antenna is working; the different working conditions include: different azimuth angles, different elevation angles and different windward areas;
the preset antenna points are picked up from the reflector structure of the antenna so that the wind force information of each preset point can represent the entire wind field of the antenna;
the first correspondence between the wind force information of each preset antenna point and the wind field of the antenna under the corresponding working condition is determined.

3. The method according to claim 2, wherein the step of obtaining the temperature information of the preset antenna points at multiple historical moments to determine the historical temperature field of the antenna specifically comprises:
for each historical moment, according to the temperature information of the preset points of the reflector structure of the antenna at that historical moment, a segmented and regional Hermite interpolation method is used for the reflector structure of the antenna to determine the temperature information of each structural node of the reflector structure of the entire antenna;
according to the temperature information of each structural node of the reflector structure of the entire antenna, the temperature field of the reflector structure of the entire antenna is deduced through an orthogonal matching analysis algorithm.

4. The method according to claim 1, wherein the step of “obtaining a true deviation of the antenna pointing under the influence of the historical wind field and the historical temperature field, so as to train a first prediction model according to the historical wind field, the historical temperature field and the true deviation, and obtain an antenna pointing deviation prediction model for predicting the antenna pointing deviation” specifically includes:
obtain an actual azimuth and actual elevation angle of the antenna when the antenna is pointing at a detection target under the influence of the historical wind field and the historical temperature field;
according to a spatial position relationship between the detection target and the antenna, determine a theoretical azimuth and theoretical elevation angle of the antenna when the antenna is pointing at the detection target;
according to the difference between the actual azimuth and the theoretical azimuth, and the difference between the actual elevation angle and the theoretical elevation angle, determine the true deviation of the antenna pointing under the influence of the historical wind field and the historical temperature field;
input the historical wind field and the historical temperature field into the first prediction model to determine a predicted deviation of the antenna pointing under the influence of the historical wind field and the historical temperature field at the historical moments, and train the first prediction model with the goal of minimizing the difference between the predicted deviation and the true deviation to obtain the antenna pointing deviation prediction model.

5. The method according to claim 1, wherein the step of “actively adjusting a pointing direction of the antenna so that the antenna can accurately point to a target at the next moment” specifically comprises:
according to the pointing deviation of the antenna under the influence of the predicted temperature field and the predicted wind field, the corresponding control factors of each control link of an antenna control system is decomposed;
the antenna control system actively adjusts the pointing direction of the antenna based on various control factors so that the antenna can accurately point at the detection target at the next moment; wherein the control factors include: azimuth angle, elevation angle, torque in each direction of a azimuth motor, and control torque in each direction of a pitch motor.

6. A device for actively controlling antenna pointing under the influence of environmental factors, comprising:
an acquisition module, configured for determining a historical wind field and a historical temperature field of an antenna according to wind force information and temperature information of preset antenna points at multiple historical moments, so as to establish a first correspondence between the wind force information and the wind field of the preset antenna points and a second correspondence between the temperature information and the temperature field of the preset antenna points;
a deviation module, configured for obtaining a true deviation of the antenna pointing under the influence of the historical wind field and the historical temperature field, so as to train a first prediction model according to the historical wind field, the historical temperature field and the true deviation, and obtain an antenna pointing deviation prediction model for predicting the antenna pointing deviation;
a determination module, configured for obtaining the wind force information and temperature information of the preset antenna points within a current preset period, determining the wind field of the antenna within the current preset period according to the wind force information of the preset antenna points and the first correspondence, and determining the temperature field of the antenna within the current preset period according to the temperature information of the preset antenna points and the second correspondence;
a prediction module, configured for predicting a predicted temperature field and a predicted wind field of the antenna at a next moment by a second prediction model based on the wind field and temperature field of the antenna in the current preset time period, wherein the second prediction model is obtained through training by taking the wind field and temperature field of the antenna in a historical time period as samples and the wind field and temperature field of the antenna at the next moment after the historical time period as annotations;
a control module, configured for inputting the predicted temperature field and predicted wind field of the antenna at the next moment into the antenna pointing deviation prediction model to determine a pointing deviation of the antenna under the influence of the predicted temperature field and the predicted wind field so as to actively adjust a pointing direction of the antenna so that the antenna can accurately point to a target at the next moment;
wherein the acquisition module is further configured in such a way that:
an ideal wind field model at the antenna site and the reflector structure of the antenna under different working conditions are coupled by a machine learning model to determine the wind field under different working conditions when the antenna is working; the different working conditions include: different azimuth angles, different elevation angles and different windward areas;
the preset antenna points are picked up from the reflector structure of the antenna so that the wind force information of each preset point can represent the entire wind field of the antenna;
the first correspondence between the wind force information of each preset antenna point and the wind field of the antenna under the corresponding working condition is determined.

7. A computer-readable storage medium, wherein the storage medium stores a computer program, and when the computer program is executed by a processor, the method according to claim 1 is implemented.

8. A computer device, comprising a memory, a processor and a computer program stored in the memory and executable on the processor, wherein the processor implements the method according to claim 1 when executing the program.
